(19) United States
(12) Patent Application Publication
(10) Pub. No.: US 2026/0244671 A1
(43) Pub. Date: Aug. 20, 2026

(54) CUSTOMIZED LLM RESPONSES BY GROUP PREFERENCE ALIGNMENT

(71) Applicant: Microsoft Technology Licensing, LLC, Redmond, WA (US)

(72) Inventors: Jennifer Lynay NEVILLE, West LaFayette, IN (US); Sujay Kumar Jauhar, Kirkland, WA (US); Jack Wilson Stokes, III, North Bend, WA (US); Mengting Wan, Kirkland, WA (US); Longqi Yang, Issaquah, WA (US); Ishani Mondal, College Park, MD (US)

(21) Appl. No.: 19/194,964

(22) Filed: Apr. 30, 2025

Related U.S. Application Data
(60) Provisional application No. 63/758,822, filed on Feb. 14, 2025.

(51) Int. Cl. G06F 16/335; H04L 51/216

(52) U.S. Cl. CPC G06F 16/335; H04L 51/216

(57) ABSTRACT

Group-based, intent-aware large language model (LLM) customization is provided. A method includes prompting a first generative model to extract and associate implicit judgments from user responses in real-world conversation logs, the implicit judgments indicating preferred or dis-preferred with a conversation associated with a respective conversation log of the conversation logs, prompting the first or a second generative model to summarize the implicit judgments from the first generative model into generalized preference aspects resulting in group-specific rubrics, the group-specific rubrics indicate significant differences in the generalized preference aspects between groups, and based on the group-specific rubrics from the generative model, (i) augmenting a prompt to a third generative model resulting in an augmented prompt and providing the augmented prompt to the third generative model or (ii) fine-tuning the third generative model, resulting in a group-aligned generative model that provides responses in alignment with a group-specific rubric of the group-specific rubrics.

### RELATED APPLICATION

This application claims the benefit of priority to U.S. Provisional Patent Application No. 63/758,822 titled “GROUP PREFERENCE ALIGNMENT: EXTRACTING CONTEXTUAL GROUP PREFERENCES FROM IN-SITU CONVERSATIONS TO CUSTOMIZE RESPONSE GENERATION” and filed on Feb. 14, 2025, which is incorporated herein by reference in its entirety.

### TECHNICAL FIELD

Aspects regard customizing a large language model (LLM) prompt to meet specialized needs of distinct user groups.

### BACKGROUND

Generative models often fail to meet the specialized needs of distinct user groups due to their one-size-fits-all training paradigm.

### SUMMARY

Generative model technologies often fail to meet the specialized needs of distinct user groups due to their one-size-fits-all training paradigm. To address this limitation of generative model technologies, group preference alignment (GPA) includes a group-aware personalization framework that identifies context-specific variations in conversational preferences across groups and then steers generative models to address those preferences. The GPA approach includes two steps: (1) group-aware preference extraction, where maximally divergent user-group preferences are extracted from real-world conversation logs and distilled into interpretable rubrics, and (2) tailored response generation.

A method for aligning generative model responses with group-specific user preferences can include prompting a first generative model to extract and associate implicit judgments from user responses in real-world conversation logs, the implicit judgments indicating preferred or dis-preferred with a conversation associated with a respective conversation log of the conversation logs. The method can further include prompting the first or a second generative model to summarize the implicit judgements from the first generative model into generalized preference aspects resulting in group-specific rubrics, the group-specific rubrics indicate significant differences in the generalized preference aspects between groups. The method can further include based on the group-specific rubrics from the generative model, (i) augmenting a prompt to a third generative model resulting in an augmented prompt and providing the augmented prompt to the third generative model or (ii) fine-tuning the third generative model, resulting in a group-aligned generative model that provides responses in alignment with a group-specific rubric of the group-specific rubrics.

The method can further include receiving a partial conversation log of a conversation between a user and the third generative model. The method can further include determining, by prompting the first generative model and based on the partial conversation log, a group to which the user belongs, the group associated with an expertise in a subject matter, a geographical region, or a combination thereof.

Augmenting can include altering the prompt to the third generative model to include a group-specific rubric of the group-specific rubrics associated with the group of the user. The group-specific rubric can summarize intent-specific guidance for generative model responses for the group. Fine-tuning can include altering the third generative model by finetuning the generative model. Finetuning the third generative model can include training the third generative model based on pairs of contrastive augmented conversation examples, the pairs of contrastive augmented conversation examples including conversation examples associated with an implicit judgement of preferred and conversation examples associated with an implicit judgement of dis-preferred.

A first contrastive augmented conversation example of a pair of the contrastive augmented conversation examples can be synthetically generated and a second contrastive augmented conversation example of the pair is from real-world conversation logs. Finetuning can include using a direct preference optimization function that trains the third generative model to provide responses aligned with the rubric and to not provide responses reflecting the conversation examples that are dis-preferred.

Summarizing the implicit judgments into generalized preference aspects to create group-specific rubrics can include prompting the first generative model to, based on conversations between the third generative model and corresponding users of groups of users, provide an indication of whether the user was satisfied or dissatisfied with the conversation and an explanation of why the user was satisfied or dissatisfied. Summarizing the implicit judgments into generalized preference aspects to create group-specific rubrics can include identifying divergent preferences between groups of users based on whether the user was satisfied or dissatisfied and the explanations. Summarizing the implicit judgments into generalized preference aspects to create group-specific rubrics can include scoring the divergent preferences. Summarizing the inferred expectations into generalized preference aspects to create group-specific rubrics further includes adding a divergent preference of the divergent preferences to a corresponding group-specific rubric of the group-specific rubrics.

Another method can include obtaining (i) a user query to a first generative model by a user and (ii) a partial conversation associated with the user query. The method can further include retrieving, based on a group of groups to which the user belongs and from a rubric database, a group-specific rubric of previously stored group-specific rubrics. The method can further include dynamically adjusting the user query during inference by incorporating the group-specific rubric into a prompt, resulting in an augmented prompt. The method can further include providing the augmented prompt to the first generative model. The method can further include providing a response to the augmented prompt, and from the first generative model, to the user.

The group can be associated with an expertise in a subject matter, a geographical region, or a combination thereof. The group-specific rubric can summarize intent-specific guidance for generative model responses for the group.

### BRIEF DESCRIPTION OF DRA WINGS

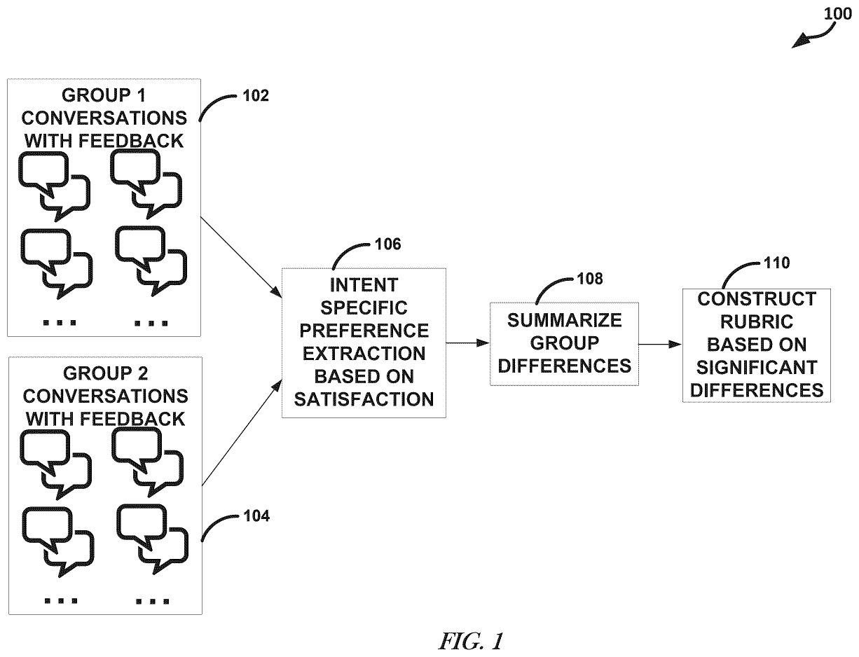

FIG. 1 illustrates, by way of example, a diagram of an embodiment of a method for identifying salient differences between group preferences and generating corresponding rubrics.

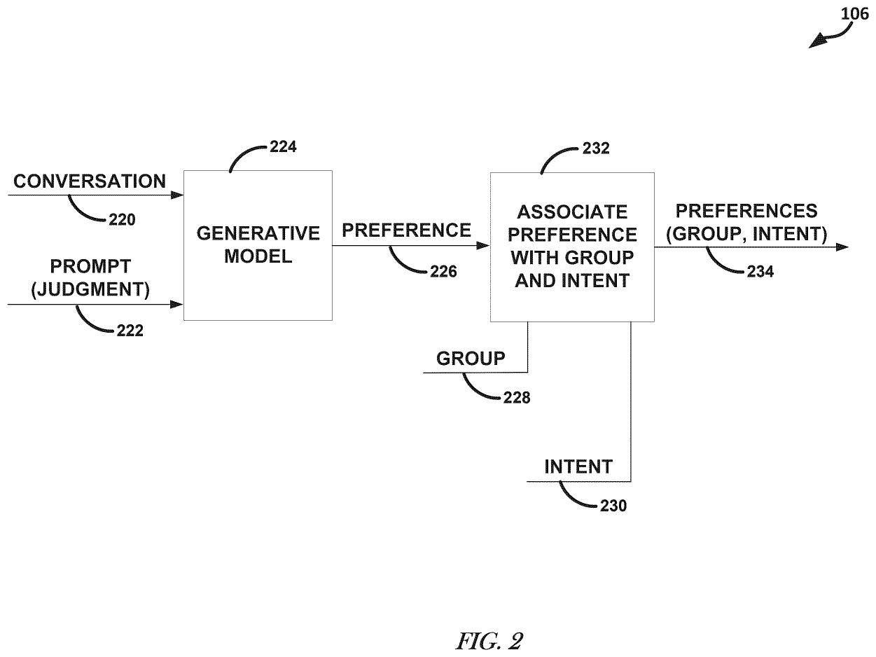

FIG. 2 illustrates, by way of example, a diagram of an embodiment of performing the preference extraction operation of FIG. 1.

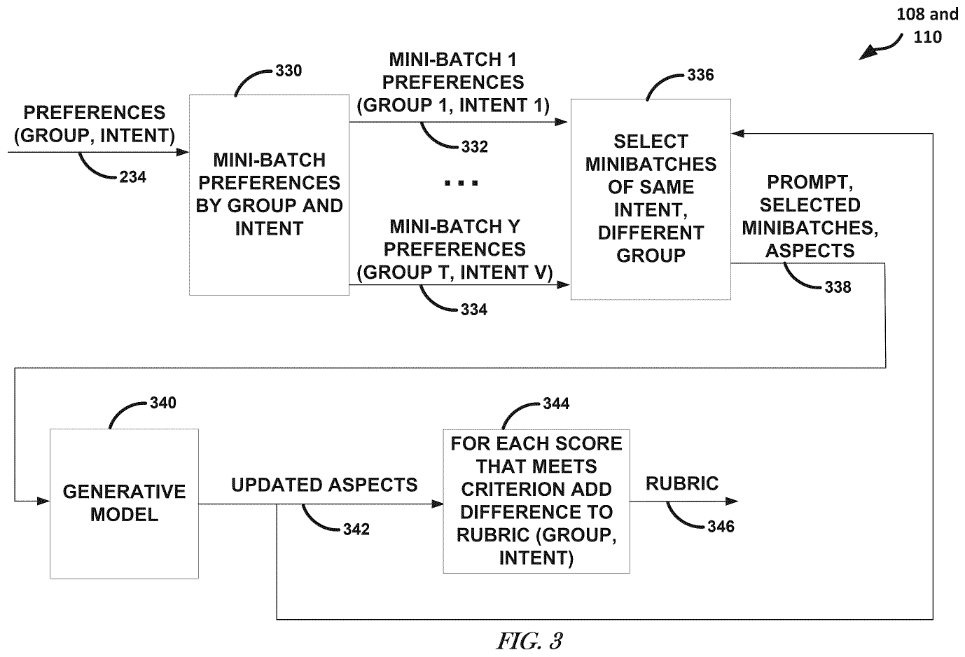

FIG. 3 illustrates, by way of example, a diagram of an embodiment of some operations from FIG. 1.

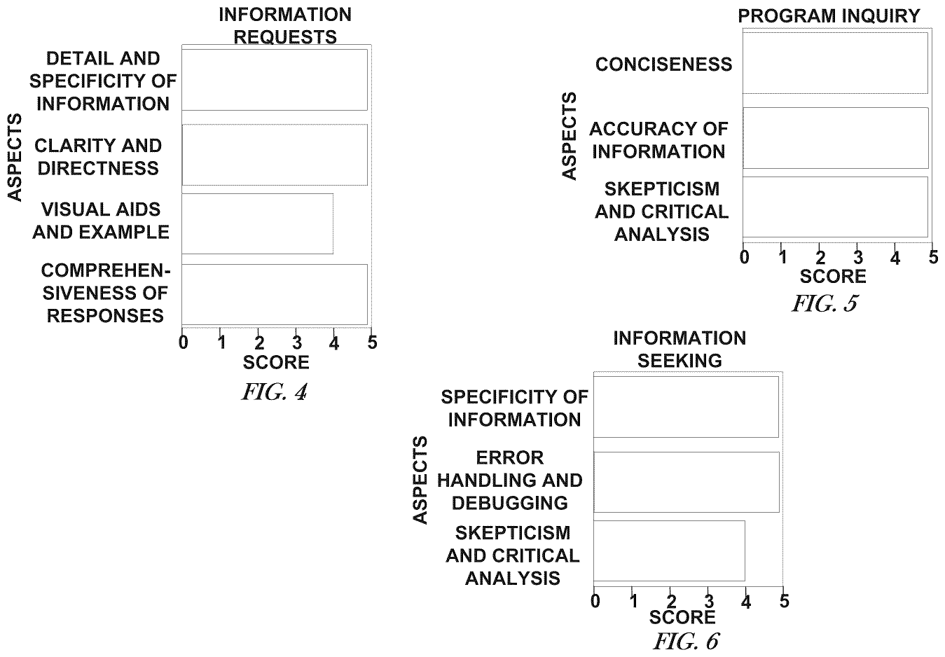

FIGS. 4-6 illustrate, by way of example, respective bar graphs of some aspects of rubrics and corresponding Likert scores for each of the aspects for respective intents.

FIG. 7 illustrates, by way of example, a diagram of an embodiment of a method for GPA-CT (dynamic context-tuning).

FIG. 8 illustrates, by way of example, a diagram of an embodiment of a method for GPA-FT.

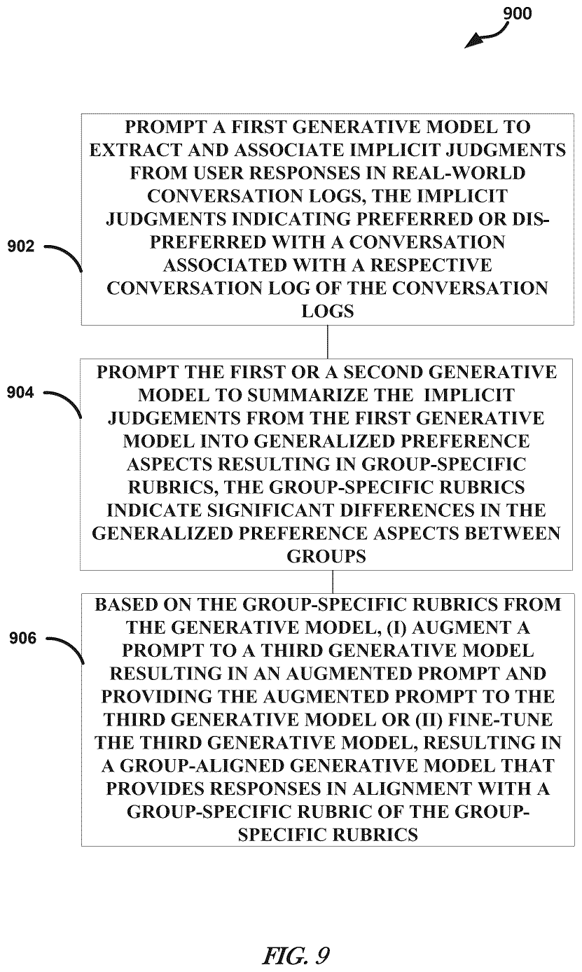

FIG. 9 illustrates, by way of example, a bar graph of a WTR evaluation using the Gemma model.

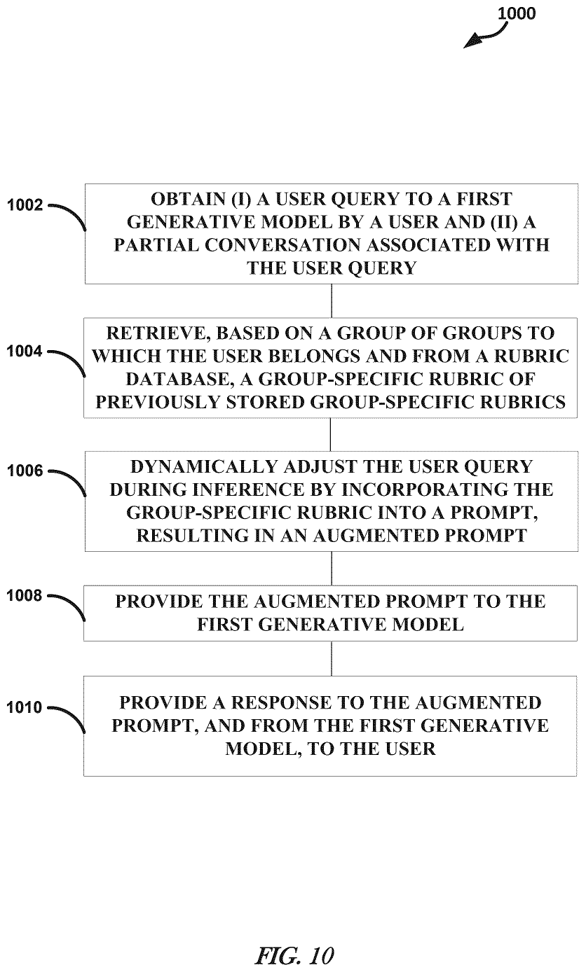

FIG. 10 illustrates, by way of example, line graphs of a number of valid rubrics versus type of minibatching for a variety of intents.

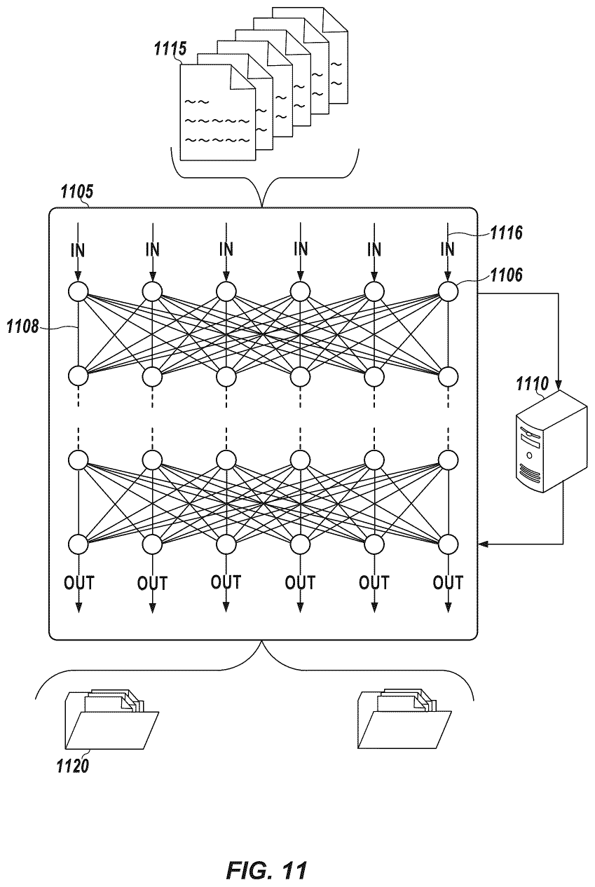

FIG. 11 illustrates, by way of example, a diagram of an embodiment of a method for generative model alignment with user preferences.

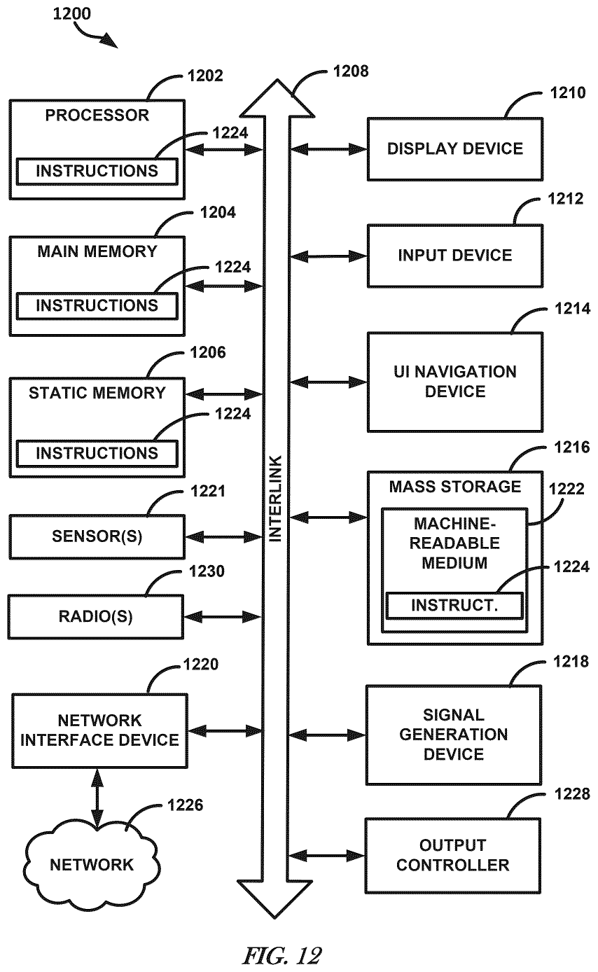

FIG. 12 illustrates, by way of example, a diagram of an embodiment of another method for generative model alignment with user preferences.

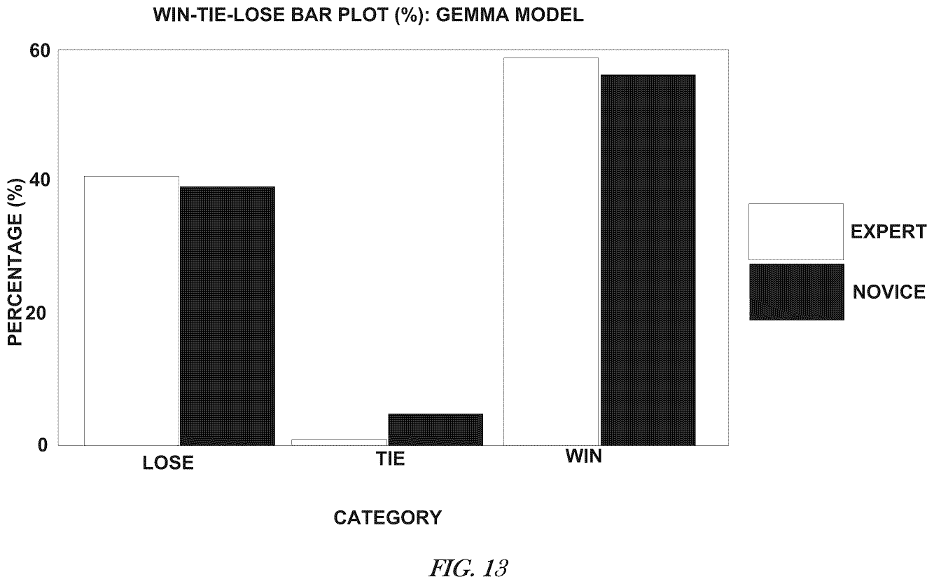

FIG. 13 is a block diagram of an example of an environment including a system for neural network (NN) training.

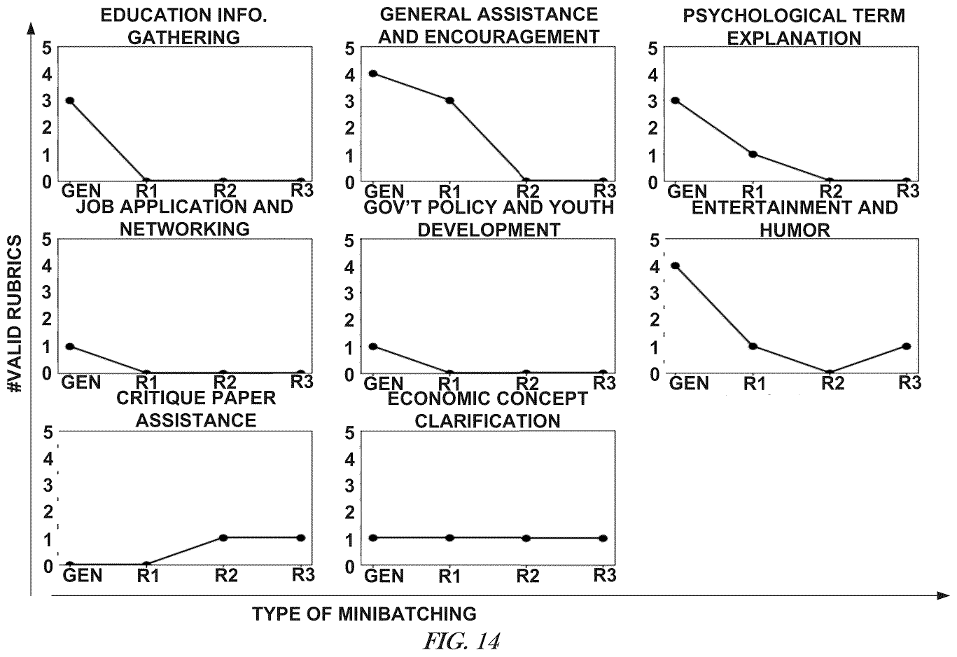

FIG. 14 illustrates, by way of example, a block diagram of an embodiment of a machine in the example form of a computer system within which instructions, for causing the machine to perform any one or more of the methodologies discussed herein, may be executed.

### DETAILED DESCRIPTION

The following description and the drawings sufficiently illustrate teachings to enable those skilled in the art to practice them. Other embodiments may incorporate structural, logical, electrical, process, and other changes. Portions and features of some examples may be included in, or substituted for, those of other examples. Teachings set forth in the claims encompass all available equivalents of those claims.

Generative model technologies often fail to meet the specialized needs of distinct user groups due to their one-size-fits-all training paradigm. To address this limitation of generative model technologies, group preference alignment (GPA) includes a group-aware personalization framework that identifies context-specific variations in conversational preferences across groups and then steers generative models to address those preferences. The GPA approach includes two steps: (1) Group-Aware Preference Extraction, where maximally divergent user-group preferences are extracted from real-world conversation logs and distilled into interpretable rubrics, and (2) Tailored Response Generation, which leverages these rubrics through two methods: a) Context-Tuned Inference (GPA CT), that dynamically adjusts responses via context-dependent prompt instructions, and b) Rubric-Finetuning Inference (GPA-FT), which uses the rubrics to generate contrastive synthetic data for personalization of group specific models via alignment. Experiments demonstrate that the GPA framework significantly improves alignment of the output with respect to user preferences and outperforms baseline methods through automated evaluations, while maintaining robust performance on standard benchmarks.

Generative models are pivotal in modern natural language processing (NLP), driving technologies and technical fields of conversational agents, content generation, and automated reasoning. Despite their remarkable capabilities, generative models often fall short in addressing the specialized needs of distinct user groups due to their one-size-fits-all training paradigm which predominantly rely on paired preference data obtained by asking human/generative model judges to provide ratings (e.g., preferred and dispreferred) to alternative outputs for the same input prompt. These approaches assume that human and AI annotators accurately reflect the preferences of the target user population. When models are aligned to this preference data, model outputs will be steered toward the most prevalent preferences of the annotator population, even when users express diverse preferences for the same task/query. Broad preference alignment like this can lead generative models to produce suboptimal outputs for a target user base for two primary reasons. First, the distribution of preferences in the target population may differ from those expressed in the annotator population. Examples include domain-specific expertise (i.e., if annotators are generally non-experts, but the target users are experts) and cultural norms (e.g., Japanese audiences may prefer narratives on family bonding, while U.S. audiences favor individualistic themes).

Second, even across populations, preference differences may vary with respect to domain/task. For instance, in education, experts may expect precise terminology and assume foundational knowledge, while novices may desire real-world analogies and step-by-step explanations. In programming, experts often prefer concise debugging strategies, whereas novices may seek explicit concept explanations with visual aids. Despite these insights, existing methods often rely on synthetic preference data or broadly defined personas, however, these contextual shifts cannot be fully captured through pre-defined rules or generic preference tuning alone. Instead, real-world user bot conversations provide the most accurate signals of how users express implicit preferences in different scenarios, thereby motivating us to learn situation-aware preferences from real-world interactions before tailoring responses.

To address this, GPA automatically identifies context-specific variations in conversational preferences across user groups and steers generative models to address those preferences. GPA is a two-step framework, which comprises the following technical components: A first component that aims to extract salient group preference differences from real-world conversation logs. The output is then distilled into interpretable rubrics that summarize intent-specific guidance for each group. A second component that, at the time of inference, implements one of two methods to use these rubrics to tailor personalized responses for each group. (1) GPA-CT dynamically adjusts responses via context-dependent in-prompt augmentation, which is data-efficient and training-free, and (2) GPA-FT uses the learnt rubrics to generate contrastive synthetic data to fine-tune separate models towards group-specific preferences.

Experiments demonstrate that both inference approaches significantly outperform baseline methods, including static-preference and zero-shot models, as judged by a GPT4-as-a-judge evaluation. Notably, GPA achieves these improvements without compromising the generative model's core capabilities, as evidenced by robust performance on standard benchmarks such as MT-Bench and Arena-Hard.

Customization of user interactions to better serve both individual and group preferences has a long history of research in a range of fields that leverage language technology. These include recommender systems, search and information retrieval, education, and healthcare.

Generative models are trained in a one-size-fits-all paradigm where large-scale ratings from auxiliary human annotators or generative models in a paired preference setup is used to teach models to generate preferred responses. This can make generative models difficult to customize. Nevertheless, recent work has begun to advocate for the need for generative models to serve more diverse preferences through pluralistic alignment. Much of the work in generative model customization has focused on personalizing systems to the individual. These have used a variety of different approaches, including retrieval-augmented generation, memory, parameter-efficient fine-tuning, and reinforcement learning. Personalized generative model systems have also been applied to diverse applications, such as contextual query suggestion (Baek et al., 2024) and document creation.

Recently some attempts have been made at modeling a large number of individual characteristics at scale, such as with a thousand preferences or a million personas. However, the focus on modeling group preferences has been limited to a few recent research efforts. Crucially, none of these methods leverage real-world conversational data at scale to learn these group preferences. While some recent work has begun to incorporate feedback from in-situ user-AI interactions to improve models, their focus has been different from modeling group preferences.

Reference will now be made to the FIGS. to describe further details of GPA.

FIG. 1 illustrates, by way of example, a diagram of an embodiment of a method 100 for identifying salient differences between group preferences and generating corresponding rubrics. The rubrics capture the distinct preference patterns of the two user groups across intents. Example rubrics are provided elsewhere including in Table 4. The rubric can then be used to improve generative model performance when responding to a given group associated with a rubric. The method 100 relies on conversations that include user satisfaction feedback. The method 100 assumes that conversations have been organized into groups (tagged as belonging to a specific group). The groups can include a topic and expertise level, a place of origin (e.g., a country, a state, a province, or other place of origin), an individual, or the like. The groups can have preferences for generative model responses that can be contrasted with preferences for generative model responses of one or more other groups. The illustrated conversations include conversations 102 conducted by respective users of a first group and conversations 104 conducted by respective users of a second group. The feedback in the conversations include feedback from the individual(s) that are part of the group. The feedback can indicate whether the individual that conducted a conversation with the generative model was satisfied, dissatisfied, or the like.

An example prompt to provide expertise labeling is now provided:
LLM.ExpertiseLabeling
#OVERVIEW
You will be given a conversation history between a User and an AI agent. Your task is to determine user's expertise in the subject of the conversation.
#USER EXPERTISE
User expertise levels in a conversation subject range from novice, indicating a lack of familiarity with fundamental concepts, to expert or master, denoting a deep understanding of relevant vocabulary, concepts, and principles.
   Novice: A subject novice is a person who has little or no familiarity with a specific topic or domain.
A subject novice may ask questions that are vague, general, irrelevant, or based on incorrect assumptions. A subject novice may also have difficulty understanding the terminology, concepts, or arguments of experts or more knowledgeable people in the subject. They may ask basic or general questions that can be answered by simple definitions, examples, or facts. They may not be aware of the sources, methods, concepts, or terminology that are relevant to the subject.
   Intermediate: A subject intermediate is someone who has some basic knowledge or familiarity with a certain topic, but not enough to be considered an expert or a novice. A subject intermediate can ask general questions that reflect their curiosity or interest in the topic, but not very specific or complex ones that require deeper understanding or analysis. A subject intermediate might have learned some terms or concepts related to the topic, but not how to apply them in different contexts or situations.
   Expert: A subject expert is someone who can apply relevant concepts and terminology to different scenarios and problems. They can analyze and interpret data, compare and contrast different methods or approaches, and justify their reasoning with evidence. The user also demonstrates curiosity and interest in the subject by asking questions that go beyond the surface level and explore the deeper implications and connections of the topic. He has a deep and comprehensive understanding of a specific topic or field and can use specialized terms and references to communicate their knowledge. A subject expert can state accurate facts, provide relevant examples, and cite authoritative sources related to their topic or field.

- Unknown: There is not enough information to determine the user's
expertise.
## OUTPUT FORMAT ##
Format your output as JSON Object with key as Expertise-label and values
as either Novice, Intermediate, Expert or Unknown.
## INPUT ##
Conversation History
## OUTPUT ##

At operation 106, intent specific preference extraction based on satisfaction can be performed. A result of the operation 106 is one or more preferences (if any) of the individual(s) in the conversation 102, 104. The preferences can be aggregated by group to summarize group differences at operation 108. Significant preference differences between groups are organized into rubrics at operation 110. The preferences can include “detailed explanation beyond the obvious suggestions”, “appreciates actionable steps to solve a problem”, “expects deeper analysis rather than generic tips”, “prefers advanced and precise explanations”, among many others. More generally, a preference is a general liking for one alternative over one or more other options. In the context of generative model conversations, a preference refers to a certain characteristic of an generative model response that a user wants in the conversation to make them satisfied by the conversation. Note that a preference can be stated in a positive manner (a positive preference) or a preference can be stated in a negative manner (a negative preference or a dispreference). For example, a preference can be “I do not like a detailed summary”.

GPA leverages intent-driven user preferences that can be automatically extracted from real-world conversation logs between human and AI agents, enabling more effective model alignment than traditional methods that do not incorporate direct user feedback. Consider a user group G that generates queries for a specific intent I. To simplify notation, intent, I, encodes both domain (e.g., education) and task (e.g., summarization).

The responses from the generative model, denoted as Y_{I}=LLM(X_{I}), receive user judgments J_{G}(Y_{I}) in the form of thumb feedback or implicit textual feedback (e.g., thanking the AI). When these preferences diverge from the general population's judgments J_{P}(Y_{I}), aligning the AI model with group-specific signals will improve response relevance and user satisfaction. Note that if J_{G}(Y_{I})≈J_{P}(Y_{I}), alignment to J_{G}(Y_{I}) will simply reinforce existing preferences in the general population without degrading performance. Unlike other potential solutions which optimize for majority preferences, GPA leverages in-situ user judgments to achieve fine-grained, group-specific alignment, that is of particular use when user needs deviate significantly from broader norms.

Let C={C₁, C₂, . . . , Cₙ} represent a set of conversations from a collection of users, where each Cᵢ is an individual conversation. Let each conversation Cᵢ, consisting of t interaction turns of user-agent utterances, be represented as: Cᵢ=[U₁, A₁, . . . , Uₜ, Aₜ]. Here, Uₜ refers to a user utterance and Aₜ refers to an AI agent response. The user-agent conversations Cᵢ often consist of multiple turns, i.e. t≥1. Each conversation Cᵢ is labeled with a predicted intent Iᵢ. Each conversation turn Uₜ has been labeled with a user satisfaction judgment Jᵢ∈[−1, +1]. Finally, assume that each user u is associated with one of two groups, i.e. u∈G or u∈G′. Note that in cases where contrasting group labels are unavailable, GPA can also be used by comparing a single group G against the overall population P. No assumptions about |G| are made except that there are sufficient conversation interactions from users in G to extract preferences.

GPA enables context-aware, group-specific adaptation, ensuring more precise and effective model alignment beyond more conventional preference optimization using auxiliary annotators. The overall approach to align models with in-situ preferences involves two main steps: (i) Generating rubrics with group-aware preference extraction (the method 100) and (ii) Tailoring responses based on the extracted rubrics (discussed below).

FIG. 2 illustrates, by way of example, a diagram of an embodiment of performing the preference extraction operation 106. At operation 106, GPA automatically identifies context-specific variations in conversational preferences across user groups G and G′ 228. Given conversations 220 regarding specific intents I 230 from users in groups G and G′ 228, with satisfaction judgments J from user responses, the operation 106 uses the judgments (as summarized in a prompt 222 to a generative model 224) to infer individual preferences E 226 that explain the user's positive or negative feedback. These preferences, E+ and E− 226, from the generative model 224, are then grouped by intent Iₖ 230 for each user group G and G′ at operation 232. A result of the operation 232 is organized preferences 234, the preferences 226 organized into sets by user groups 228, intents 230, and satisfaction (sometimes called “judgment” 222).

The generative model 224 (and other generative models herein) can include a large language model (LLM), a multi-modal LLM, or another generative model. The generative model is a machine learning (ML) model designed to create new data that is similar to its training data. Generative models learn statistical structures of data and create new data that is statistically similar to the training data. Some more popular examples of generative models include many GPT models including GPT 4.0, GPT 4.5, among others, R1, PHI-4, O1, Coder, VL, Llama, Gemma, Mistral, Perplexity, Claude, among many others. Generative models can operate based on text, audio, images, video, a combination thereof, or the like. In completing a response to a prompt, the generative model can use a sub-model, model delegation, chain of thought, other orchestration to complete a prompt-response, or a combination thereof.

The operation 106, in pseudocode can be represented as:

```
Algorithm: Group-Aware Preference Extraction
Require: Conversation set C; User groups G and G′; Intent labels I; User
judgments J
Require: Likert scale threshold l; Minibatch size m
Ensure: Rubric R
Preference Extraction
  E+ = [ ]; E− = [ ]
  for each conversation Cᵢ ∈ C with tᵢ turns do
    for j = [1..tᵢ] do
      Sⱼ= [U₁, A₁, . . . , Uⱼ]Cᵢ
      # If tⱼ contains judgment, extract preference
      if J (Sⱼ ) == +1 then
        E+ = E+∪ {LLM.InferUserPreference (Sⱼ , J (Sⱼ ))}
      if J (Sj) == −1 then
        E− = E−∪ {LLM.InferUserPreference (Sⱼ , J (Sⱼ ))}
        # Group preferences E+ and E− by intent Iₖ for each
group
    E_{G}, Iₖ = {E+ | Cᵢ ∈ G, Cᵢ matches Iₖ } ∪ {E− | Cᵢ ∈ G, Cᵢ matches
    Iₖ }
    E_{G′}, Iₖ = {E+ | Cᵢ ∈ G′, Cᵢ matches Iₖ } ∪ {E− | Cᵢ ∈ G′, Cᵢ matches
    Iₖ
```

The pseudocode shows how group-specific preference rubrics are learned based on user conversations and their corresponding intent labels or context. The input includes a conversation set C, user groups G and G′, intent labels I, user judgments J, a Likert scale threshold l, and a minibatch size m. The algorithm processes each conversation Cᵢ consisting of tᵢ interaction turns. For each turn Sⱼ, the algorithm checks whether the turn is associated with a user judgment J(Sⱼ). If the turn expresses implicit satisfaction (SAT) or dissatisfaction (DSAT) (i.e. abs (J(Sⱼ))=1), an LLM is used to infer individual preferences and generate an explanation (E+ or E− for SAT and DSAT judgments, respectively). A prompt 222 to get the generative model 224 to infer a user preference for a SAT judgment can be as follows:

LLM.InferUserPreference (for SAT judgment)
# OVERVIEW
You will be given a conversation between a User and an AI agent. Your
task is to assess the reasons of user's happiness based on the conversation
history and the bot response.
# TASK:
Classify the user's intent from the conversation {conversation history}.
Also determine what the user expects from the bot and why the user finds
the bot's response {user remarks} useful.
Determine based on whatever the user remarks after the bot's response
{user remarks}.
# ANSWER FORMAT
Format your output as a JSON Object where the keys are user-intent, user-
expectation-from-bot and reasons-for-happiness. Do not output anything
else except this.

A prompt 222 to get the generative model 224 to infer a user preference for a DSAT judgment can be as follows:

LLM.InferUserPreference (for DSAT judgment)
# OVERVIEW
You will be given a conversation between a User and an AI agent. Your
task is to assess the reasons of user's frustration based on the conversation
history and the bot response.
# TASK:
Classify the user's intent from the conversation {conversation history}.
Also determine what the user expects from the bot and why the user finds
the bot's response {user remarks} frustrating.
Determine based on whatever the user remarks after the bot's response
{user remarks}.
# ANSWER FORMAT
Format your output as JSON Object where the keys are user-intent, user-
expectation-from-bot and reasons-for-frustration. Do not output anything
else except this.

Next, the preferences are summarized into generalized preference aspects A, at operation 108. At operation 110, salient differences between two groups are captured and constructed into a rubric. The resulting group-specific rubrics serve as the foundation for group-aware customization.

FIG. 3 illustrates, by way of example, a diagram of an embodiment of the operations 108 and 110 from FIG. 1. The operation 108, as discussed, summarizes differences between preferences 226 of the groups 228. The operation 110, identifies significant differences between two groups and constructs the differences into a rubric. These two operations 108, 110 are described and illustrated together. Pseudocode for performing the two operations 108, 110 is also provided.

For each intent 230 Iₖ∈I, the operation 108 partitions the preferences of each user group 228 (G, G′) into minibatches 332, 334 of size m at operation 330. An operation 336 then iteratively selects pairs of minibatches 332, 334, one preference 226 from each group 228, and aspects (preferences or dispreferences that are not completely formed yet). Selected minibatches of preferences in prompt 338 are then summarized by a generative model 340 as updates to the aspects. A summary 342 that includes updated aspects indicates differences between the preferences (thus far in the process) scored and interpreted into concise natural language descriptions. Specifically, for a pair of minibatches

$$( {E}_{G , {I}_{k}}^{a} and {E}_{{G}^{′} , {I}_{k}}^{b} ) ,$$

the operation 110 extracts a set of aspects A that summarize how a preference 226 differs across the two groups 228.

The generative model 340 is prompted to estimate, by prompt 338, a divergence score r (e.g., based on a Likert scale) to rate the significance of each aspect. At operation 344 it is determined whether the divergence score r meets a specified criterion (e.g., the divergence score r exceeds a threshold l). The divergence meeting the criterion indicates a significant difference in preferences between the two groups. For each score that meets or exceeds the criterion, the aspect Aab is added to a rubric 346 for the current intent R_{I}_{ₖ} at operation 344.

Each iteration can be provided the aspects (the rubric 346) from the previous iteration, so the operation 110 can update/refine the aspects as it processes all the minibatches 332, 334. The operation 110 continues identifying significant divergent aspects and includes them in the rubric 346 R_{I}_{ₖ}. The rubric for this intent is added to the global rubric list R. The algorithm returns the full set of rubrics R and an interpretation of each rubric from the summary 342 provided by the generative model 340. The rubrics 346 capture the distinct preference patterns of the two user groups across intents. Pseudocode for the operations 108 and 110 is provided:

```
Aspect-Based Rubric Construction
# Initialize an empty list of rubric items
R = []
for each intent Iₖ ∈ I do
    # Uniformly partition each explanation set into minibatches
    ${E}_{G , {I}_{k}} = \{ {E}_{G , {I}_{k}}^{1} , … {E}_{{G}^{′} , {I}_{k}}^{{n}_{1}} \} s . t . ∀ a \vert {E}_{G , {I}_{k}}^{a} \vert = m$
    ${E}_{{G}^{′} , {I}_{k}} = \{ {E}_{{G}^{′} , {I}_{k}}^{1} , … {E}_{{G}^{′} , {I}_{k}}^{{n}_{1}} \} s . t . ∀ b \vert {E}_{{G}^{′} , {I}_{k}}^{b} \vert = m$
    A_{I}_{ₖ} = []; R_{I}_{ₖ} = {}
    $for each pair of minibatches ( {E}_{G , {I}_{k}}^{a} , {E}_{{G}^{′} , {I}_{k}}^{b} ) do$
        # Extract/update divergent aspects A
        # Score group divergence on Likert scale r
        [A_{ab}, r_{ab}] = LLM.ExtractAspectsAndLikert (E_{G,I}_{ₖ}, E_{G′,I}_{ₖ}, A_{I}_{ₖ})
        A_{I}_{ₖ} = A_{ab}; r_{I}_{ₖ} [A_{ab}] = r_{ab}
    R_{I}_{ₖ} = []
    for each aspect Aₖ ∈ A_{I}_{ₖ} do
        if r_{I}_{ₖ} [Aₖ] > [symbol]  then
            R_{I}_{ₖ} ← R_{I}_{ₖ} ∪ {Aₖ}
        R ← R ∪ {R_{I}_{ₖ}}
    return R
```

Where R is a rubric. An example of the prompt 338 is now provided:

LLM.ExtractAspectsAndLikert
# OVERVIEW
Compare preference explanations of two user groups based on some aspects in
{intent-name} and provide ratings of 1-5 depending on how much different are
their preference from the bot while interaction. Update the comparison output
based on what was observed previously {previous-aspects} and the current
observed differences in preference explanations between group 1 and group 2
described below. Make sure that if there is no observed datapoints for an aspect in
either group, provide the least rating in that case.
# Primary Intent
Intent : {intent}
# Preference explanations of Group 1
{preferences-of-group 1}
# Preference explanations of Group 2
{preference-of-group 2}
# Annotation Guidelines on a scale of 1-5
1 : It indicates there is no observed difference between the preferences of two
groups on this aspect,
2 : It indicates there is a minor difference between the preferences of two groups
on this aspect,
3 : It indicates moderate difference between the preferences of two groups on this
aspect,
4 : It indicates remarkable difference between the preferences of two groups on this
aspect,
5 : It indicates undoubtedly stark difference between the preferences of two
groups on this aspect.
# Output Format
The output is formatted as a JSON file where keys are aspects and values are 1)
ratings from 1-5 and 2) Interpretation of the rating in 2-3 sentences.

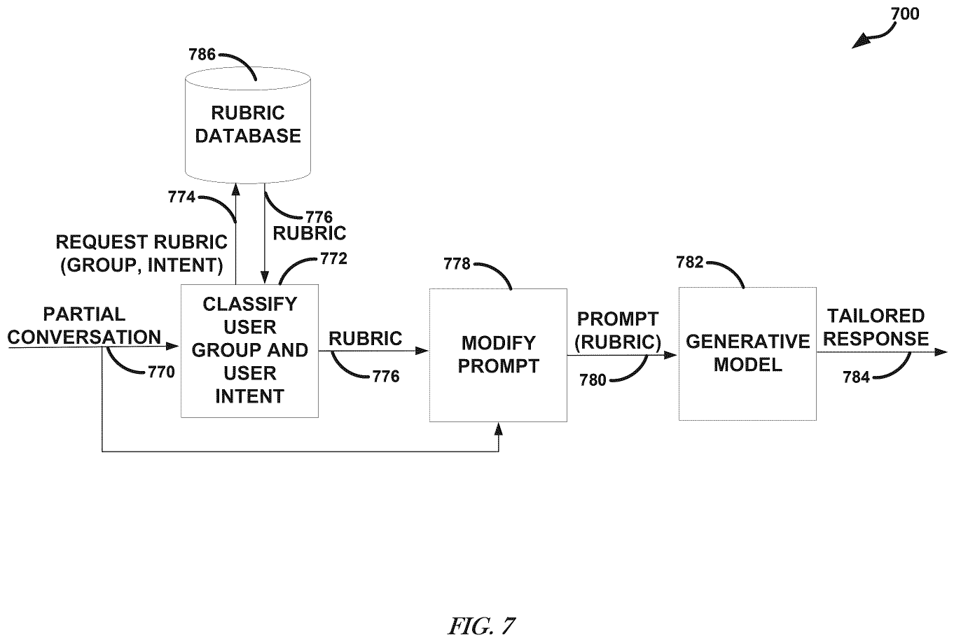

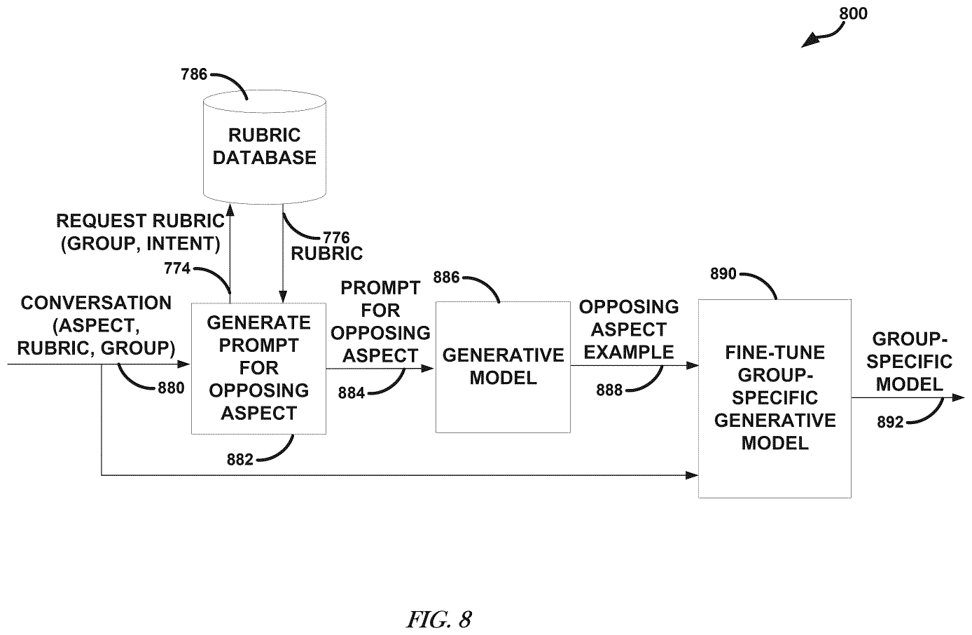

FIGS. 4-6 illustrate, by way of example, respective bar graphs of some aspects of rubrics and corresponding Likert scores for each of the aspects for respective intents. The intents illustrated include “information requests” in FIG. 4, program inquiry in FIG. 5, and information seeking in FIG. 6. The aspects jointly form a rubric for a given group and intent. The groups associated with the graphs are: (i) for FIGS. 4 and 5 education experts and novices and (ii) for FIG. 6 software programming experts and novices. The illustrated aspects include “detail and specificity of information”, “clarity and directness”, “visual aids and example”, comprehensiveness of responses”, “conciseness”, “accuracy of information”, “skepticism and critical analysis”, “specificity of information”, “error handling and debugging”, and “use of examples”. For FIG. 5, the education experts group differs strongly from the education novices group in terms of their preferences when an intent of their conversation with the generative model is for information. One of the groups wants more detail and specificity of information in a response from the generative model than the other, one of the groups wants more clarity and directness in a response from the generative model than the other, one of the groups wants more visual aids and examples in a response from the generative model than the other, and one of the groups wants more comprehensive responses in a response from the generative model than the other. The other FIGS. 5 and 6 can be interpreted accordingly.

After learning rubrics using the method 100, one of two or more methods can be used to align generative model responses based on the learnt rubrics/preferences. A first method, GPA-CT, involves dynamically augmenting prompts to produce group-aware tailored responses. GPA-CT dynamically adjusts the generative model prompts incorporating learnt rubrics during inference. The prompt is thus conditioned on intent and user group identified for each conversation.

A second approach, GPA-FT uses learnt rubrics to synthetically augment conversational data with paired responses that reflect group-specific preferences conditioned on specific intents. This process produces a tailored set of preference data. A group-specific generative model is finetuned using this enriched dataset to enhance their alignment to the targeted group.

FIG. 7 illustrates, by way of example, a diagram of an embodiment of a method 700 for GPA-CT (dynamic context-tuning). The method 700, context-tuning with GPA-CT, is an adaptive process that infers the group and intent of a user and retrieves the relevant rubric(s) for that intent. The method 700 then modifies the instructions (“prompt”) sent to the generative model to generate the next output. Pseudocode for performing the method 700 is also provided. Unlike finetuning, which adjusts weights of a model based on a fixed training dataset, context-tuning allows for dynamic adjustments to the generative model prompt based on real-time analysis of user intent and group membership. This means the generative model can adapt to the specific needs of different groups on-the-fly without requiring specialized group-specific models. The advantage of GPA-CT over finetuning includes the flexibility to adapt to user-specific needs without retraining and enhanced efficiency (as it avoids the extensive resources typically required for finetuning)

The method 700 as illustrated includes receiving a partial conversation 770 between a user and a chatbot. The partial conversation 770 includes at least one user turn (i.e., one user inquiry). The partial conversation 770 is classified at operation 772. The operation 772 determines the user group and intent based on the partial conversation 770. The operation 772 can be performed by a machine learning (ML) model such as a multi-layer perceptron that operates based on text embedding, a generative model classifier via prompting. The operation 772 can be performed by providing the group and intent based on metadata of the conversation. The operation 772 issues a request 774, to a rubric database 786, for a rubric 776 based on the determined group and intent. The rubric database 786 stores the rubrics 776 for the groups. The operation 772 provides the rubric 776 to a modify prompt operation 778. The modify prompt operation 778 augments a most recent user inquiry from the partial conversation 770 to include the rubric 776. The rubric 776 can be included in a prompt 780. The prompt 780 with the rubric 776 can be provided to the generative model 782. The generative model 782 (“chatbot”) can issue a tailored response 784 that is consistent with the requirements of the rubric 776. Pseudocode for performing the method 700 is now provided:

```
Require: Partial conversation Sᵢ = [U₁, A₁, . . . , Uⱼ ] up to j^{th} user
utterance
Require: Rubric R
Ensure: LLM answer Aⱼ
Step 1: Classify user group and intent
    Iᵢ = Intent(Sᵢ)
  Gᵢ = Group(Sᵢ)
Step 2: Retrieve Rubric and Augment Prompt
  Rᵢ = R_{Ii}
  Aⱼ = LLM.ModifyPromptWithRubrics(Sᵢ, Gᵢ, Rᵢ)
  return Aⱼ
```

GPA-FT, which is generated by rubric-guided contrastive data generation and fine-tuning, is now described. Rather than fine-tuning generative models with the training data comprising one-sided preference signals from user groups (G and G′), GPA-FT uses learned rubrics to generate more realistic contrastive pairs that vary according to observed preference dimensions in the extracted rubrics. GPA-FT may be favored over GPA-CT in situations where the generative model is less steerable with prompt-tuning (e.g., smaller models) and/or when lower latency is desired for inference.

FIG. 8 illustrates, by way of example, a diagram of an embodiment of a method 800 for GPA-FT. With GPA-FT, generative models are finetuned using synthetic training data generated with intent- and group-aware rubrics (from the rubric database 786) to reflect in-situ user preferences. Pseudocode of rubric-guided data generation and fine-tuning in GPA-FT is provided along with more details of the GPA-FT process.

The method 800 takes as input a conversation 880 and augments the existing generative model response with a paired response of opposing preference polarity, conditioned on the group-aware rubrics. The response of opposing polarity is generated by a generative model 886. The generative model 886 is instructed, by a prompt 884, to generate a response with the opposing preference polarity (opposing aspect example 888). The prompt 884 is generated by operation 882. A generative model is then finetuned per group at operation 890 to provide responses that are consistent with the group preferences and do not include the opposing preference polarity (opposing aspects). A result is a bank of group-specific generative models 892. The generative models 892 include a generative model for each group. In inference, a group of a user is determined, and their prompt is routed to the generative model that has been fine-tuned for to respond consistent with their group preferences.

Consider a conversation Sᵢ up to the j^{th} user utterance, with Aⱼ referring to the corresponding AI response, and J (Sᵢ)∈{+1, −1} referring to the user satisfaction judgment for Aⱼ. To generate a contrastive augmented sample, the response can be modified as follows: If J (Sᵢ)=+1 (preferred response), a dispreferred response A_{aug} is generated by instructing the generative model to incorporate features from the opposing group's rubric for that intent. Otherwise, if J(Sᵢ)=−1 (dispreferred response), a preferred response A_{aug} is generated by instructing the generative model to align the output with the user's group rubric for that intent. When applied to the full training data, the procedure produces an augmented dataset D_{aug} where each original instance is paired with a contrastive sample: T_{aug}=(Sᵢ, A_{aug}, −J (Sᵢ)). Note that J_{aug}=−J (Sᵢ) to facilitate contrastive preference learning. Next, separate models are trained for each user group. Given a prompt S and responses A+ (preferred) and A− (dispreferred), the likelihood of selecting the preferred response is modeled as:

$${P}_{θ} ( {A}_{+} \vert S ) = {e}^{{f}_{θ} ( S , {A}_{+} )} / ( {e}^{{f}_{θ} ( S , {A}_{+} )} + {e}^{{f}_{θ} ( S , {A}_{-} )} ) \qquad ( 1 )$$

where f_{θ}(S, A) is a scoring function parameterized by θ, representing the model's preference alignment. The DPO objective is to maximize the log-likelihood of the chosen response:

$${L}_{DPO} = {𝔼}_{( S , {A}_{+} , {A}_{-} )} \sim {D}_{aug} [ log {P}_{θ} ( {A}_{+} \vert S ) ] \qquad ( 2 )$$

By optimizing L_{DPO}, the model learns to prefer responses aligned with group-specific rubrics while discouraging responses reflecting dispreferred aspects. Two specialized DPO models (P_{θ}_{_{G}} and P_{θ}_{_{G′}}) were trained using contrastive samples from D_{aug} for each. This results in: [1] P_{θ}_{_{G}}, optimized to generate responses aligned with the preferences of user group G. [2] P_{θ}_{_{G′}}, optimized for user group G′. Note that experiments were performed with KTO objective as well, but DPO was found to be superior. Pseudocode for rubric-guided data generation and fine-tuning in GPA-FT is now provided:

```
Require: Conversation set C; User groups G and G′; Intent labels I; User judgments
J; Rubrics R
Require: Model_{Base} is the base LLM model
Ensure: Model_{FT} is fine-tuned model dictionary per group
  Step 1: Generate Synthetic Data
  for each group G, G′ do
    T_{aug}, G = [ ]
  for each conversation Cᵢ ∈ C do
    Iᵢ = Intent(Cᵢ)
    Gᵢ = Group(Cᵢ)
    T_{aug},_{Gi} = T_{aug},_{Gi} ∪ {Cᵢ}
    for j = [1..tᵢ] do
      Sⱼ = [U₁, A₁, . . . , Uⱼ ]Cᵢ
      S_{j,aug} = RubricGuidedDataGeneration(Sⱼ, Iᵢ, Gᵢ, R[Iᵢ])
      T_{aug,Gi} = T_{aug,Gi} ∪ {S_{j,aug}}
  Step 2: FineTune LLM for each group
  Model_{FT} = { }
  for each group G, G′ do
    ModelFT [Gᵢ] = FineTuneLlm(Model_{Base}, T_{aug,Gi} , J )
RubricGuidedDataGeneration:
Require: Training example T = [Sᵢ, Aⱼ , J (Sᵢ)], where Sᵢ= [U₁, A₁, . . . , Uⱼ ] is a
conversation up to j^{th} user utterance, Aⱼ is the AI response, and J (Sᵢ) is the user's
preference judgement for Aⱼ
Require: Intent Iᵢ, Group Gᵢ, Rubric R_{Ii}
Ensure: Augmented training data Taug
  # Generate Augmented Training Example with Rubric
  if J (Sᵢ) == +1 then
    # Output is preferred by user, modify to include dispreferred group
aspects
    A_{aug} = LLM.ModifyPromptWithRubrics(Sᵢ, G′, Rᵢ)
    T_{aug} = [Sᵢ, A_{aug} , −1]
  if J (Sᵢ) == −1 then
    # Output is dispreferred by user, modify to include preferred group
aspects
    A_{aug} = LLM.ModifyPromptWithRubrics(Sᵢ, Gᵢ, Rᵢ)
    T_{aug} = [Sᵢ, A_{aug} , +1]
  return T_{aug}
GPA-FT: Inference
Require: Partial conversation Si = [U1, A1, . . . , Uj ] up to j^{th} user utterance
Require: Per-group, fine-tuned model dictionary Model_{FT}
Ensure: LLM answer Aⱼ
  Step 1: Classify user group
  Gᵢ = Group(Sᵢ)
  Step 2: Retrieve Group-Aware Model and generate response
  Model_{FT} = Model_{FT} [Gᵢ]
  Aⱼ = Model_{FT}, Dᵢ (Sᵢ)
  return Aⱼ
```

FIG. 9 illustrates, by way of example, a diagram of an embodiment of a method 900 for generative model alignment with user response preferences. The method 900 as illustrated includes prompting a first generative model to extract and associate implicit judgments from user responses in real-world conversation logs, the implicit judgments indicating preferred or dis-preferred with a conversation associated with a respective conversation log of the conversation logs, at operation 902; prompting the first or a second generative model to summarize the implicit judgements from the first generative model into generalized preference aspects resulting in group-specific rubrics, the group-specific rubrics indicate significant differences in the generalized preference aspects between groups, at operation 904; and based on the group-specific rubrics from the generative model, (i) augmenting a prompt to a third generative model resulting in an augmented prompt and providing the augmented prompt to the third generative model or (ii) fine-tuning the third generative model, resulting in a group-aligned generative model that provides responses in alignment with a group-specific rubric of the group-specific rubrics, at operation 906.

The method 900 can further include receiving a partial conversation log of a conversation between a user and the third generative model. The method 900 can further include determining, by prompting the first generative model and based on the partial conversation log, a group to which the user belongs, the group associated with an expertise in a subject matter, a geographical region, or a combination thereof.

Augmenting the model includes altering the prompt to the third generative model to include a group-specific rubric of the group-specific rubrics associated with the group of the user. The group-specific rubric can summarize intent-specific guidance for generative model responses for the group. The fine-tuning can include altering the third generative model by finetuning the generative model. Finetuning the third generative model can include training the third generative model based on pairs of contrastive augmented conversation examples, the pairs of contrastive augmented conversation examples including conversation examples associated with an implicit judgement of preferred and conversation examples associated with an implicit judgement of dis-preferred.

A first contrastive augmented conversation example of a pair of the contrastive augmented conversation examples is synthetically generated and a second contrastive augmented conversation example of the pair is from real-world conversation logs. Finetuning can include using a direct preference optimization function that trains the third generative model to provide responses aligned with the rubric and to not provide responses reflecting the conversation examples that are dis-preferred.

Summarizing the implicit judgments into generalized preference aspects to create group-specific rubrics can include prompting the first generative model to, based on conversations between the third generative model and corresponding users of groups of users, provide an indication of whether the user was satisfied or dissatisfied with the conversation and an explanation of why the user was satisfied or dissatisfied. Summarizing the implicit judgments into generalized preference aspects to create group-specific rubrics can include identifying divergent preferences between groups of users based on whether the user was satisfied or dissatisfied and the explanations. Summarizing the implicit judgments into generalized preference aspects to create group-specific rubrics can include scoring the divergent preferences. Summarizing the inferred expectations into generalized preference aspects to create group-specific rubrics can further include adding a divergent preference of the divergent preferences to a corresponding group-specific rubric of the group-specific rubrics.

FIG. 10 illustrates, by way of example, a diagram of an embodiment of another method 1000 for generative model alignment with user preferences. The method 1000 as illustrated includes obtaining (i) a user query to a first generative model by a user and (ii) a partial conversation associated with the user query, at operation 1002; retrieving, based on a group of groups to which the user belongs and from a rubric database, a group-specific rubric of previously stored group-specific rubrics, at operation 1004; dynamically adjusting the user query during inference by incorporating the group-specific rubric into a prompt, resulting in an augmented prompt, at operation 1006; providing the augmented prompt to the first generative model, at operation 1008; and providing a response to the augmented prompt, and from the first generative model, to the user, at operation 1010.

The group can be associated with an expertise in a subject matter, a geographical region, or a combination thereof. The group-specific rubric can summarize intent-specific guidance for generative model responses for the group.

Artificial Intelligence (AI) is a field concerned with developing decision-making systems to perform cognitive tasks that have traditionally required a living actor, such as a person. Neural networks (NNs) are computational structures that are loosely modeled on biological neurons. Generally, NNs encode information (e.g., data or decision making) via weighted connections (e.g., synapses) between nodes (e.g., neurons). Modern NNs are foundational to many AI applications, such as classification, device behavior modeling (as in the present application) or the like. The generative model 224, 340, 782, 886 or a component thereof can be implemented using an NN.

Many NNs are represented as matrices of weights (sometimes called parameters) that correspond to the modeled connections. NNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the NN graph—if the threshold is not exceeded then, generally, the value is not transmitted to a down-graph neuron and the synaptic connection remains inactive. The process of weighting and testing continues until an output neuron is reached; the pattern and values of the output neurons constituting the result of the NN processing.

The optimal operation of most NNs relies on accurate weights. However, NN designers do not generally know which weights will work for a given application. NN designers typically choose a number of neuron layers or specific connections between layers including circular connections. A training process may be used to determine appropriate weights by selecting initial weights.

In some examples, initial weights may be randomly selected. Training data is fed into the NN, and results are compared to an objective function that provides an indication of error. The error indication is a measure of how wrong the NN's result is compared to an expected result. This error is then used to correct the weights. Over many iterations, the weights will collectively converge to encode the operational data into the NN. This process may be called an optimization of the objective function (e.g., a cost or loss function), whereby the cost or loss is minimized.

Backpropagation has become a popular technique to train a variety of NNs. Any well-known optimization algorithm for back propagation may be used, such as stochastic gradient descent (SGD), Adam, etc.

FIG. 11 is a block diagram of an example of an environment including a system for neural network (NN) training. The system includes an artificial NN (ANN) 1105 that is trained using a processing node 1110. The processing node 1110 may be a central processing unit (CPU), graphics processing unit (GPU), field programmable gate array (FPGA), digital signal processor (DSP), application specific integrated circuit (ASIC), or other processing circuitry. In an example, multiple processing nodes may be employed to train different layers of the ANN 1105, or even different nodes 1106 within layers. Thus, a set of processing nodes is arranged to perform the training of the ANN 1105. The generative model 224, 340, 782, 886, another component, or a component thereof can be trained using the system of FIG. 11.

The set of processing nodes is arranged to receive a training set 1115 for the ANN 1105. The ANN 1105 comprises a set of nodes 1106 arranged in layers (illustrated as rows of nodes 1106) and a set of inter-node weights 1108 (e.g., parameters) between nodes in the set of nodes. In an example, the training set 1115 is a subset of a complete training set. Here, the subset may enable processing nodes with limited storage resources to participate in training the ANN 1105.

The training data may include multiple numerical values representative of a domain, such as an image feature, or the like. Each value of the training or input 1116 to be classified after ANN 1105 is trained, is provided to a corresponding node 1106 in the first layer or input layer of ANN 1105. The values propagate through the layers and are changed by the objective function.

As noted, the set of processing nodes is arranged to train the neural network to create a trained neural network. After the ANN is trained, data input into the ANN will produce valid classifications 1120 (e.g., the input data 1116 will be assigned into categories), for example. The training performed by the set of processing nodes 1106 is iterative. In an example, each iteration of the training the ANN 1105 is performed independently between layers of the ANN 1105. Thus, two distinct layers may be processed in parallel by different members of the set of processing nodes. In an example, different layers of the ANN 1105 are trained on different hardware. The different members of the set of processing nodes may be located in different packages, housings, computers, cloud-based resources, etc. In an example, each iteration of the training is performed independently between nodes in the set of nodes. This example is an additional parallelization whereby individual nodes 1106 (e.g., neurons) are trained independently. In an example, the nodes are trained on different hardware.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus (e.g., a programmable processor, a computer, or multiple computers).

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry, e.g., a field programmable gate array (FPGA) or an application-specific integrated circuit (ASIC).

The computing system may include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium (e.g., Storage Device)

FIG. 12 illustrates, by way of example, a block diagram of an embodiment of a machine in the example form of a computer system 1200 within which instructions, for causing the machine to perform any one or more of the methodologies discussed herein, may be executed. The method 100, 700, 800, 900, 1000, generative model 224, 340, 782, 886 or a component thereof can be implemented using, or can include the system 1200 or a component thereof. The method 100, 700, 800, 900, 1000, generative model 224, 340, 782, 886, or a component or operation thereof can be implemented or performed by the computer system 1200. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., processing circuitry, such as can include a central processing unit (CPU), a graphics processing unit (GPU), field programmable gate array (FPGA), other circuitry, such as one or more transistors, resistors, capacitors, inductors, diodes, regulators, switches, multiplexers, power devices, logic gates (e.g., AND, OR, XOR, negate, etc.), buffers, memory devices, sensors 1221 (e.g., a transducer that converts one form of energy (e.g., light, heat, electrical, mechanical, or other energy) to another form of energy), such as an IR, SAR, SAS, visible, or other image sensor, or the like, or a combination thereof), or the like, or a combination thereof), a main memory 1204 and a static memory 1206, which communicate with each other via a bus 1208. The memory 1204, 1206 can store parameters (sometimes called weights) that define operations of the processing circuitry (e.g., the processor 1202), an NN component, or other component of the system 1200. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a user interface (UI) navigation device 1214 (e.g., a mouse), a disk drive unit 1216, a signal generation device 1218 (e.g., a speaker), a network interface device 1220, and radios 1230 such as Bluetooth, WWAN, WLAN, and NFC, permitting the application of security controls on such protocols. Note that a space vehicle does not typically include a display, UI navigation device, or the like.

The machine 1200 as illustrated includes an output controller 1228. The output controller 1228 manages data flow to/from the machine 1200. The output controller 1228 is sometimes called a device controller, with software that directly interacts with the output controller 1228 being called a device driver.

### Machine-Readable Medium

The disk drive unit 1216 includes a machine-readable medium 1222 on which is stored one or more sets of instructions and data structures (e.g., software) 1224 embodying or utilized by any one or more of the methodologies or functions described herein. The instructions 1224 may also reside, completely or at least partially, within the main memory 1204, the static memory 1206, and/or within the processor 1202 during execution thereof by the computer system 1200, the main memory 1204 and the processor 1202 also constituting machine-readable media.

While the machine-readable medium 1222 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible media to facilitate communication of such software.

### Experiments and Results

A few instantiations of GPA were evaluated using real-world conversational logs from a few data sources. For the intent category programming and software, 8000 conversations from a first data source and 8200 conversations from a second data source were used. Conversations were grouped into expert (i.e. G; first data source: 2200, second data source: 6000) and novice (i.e., G′; first data source: 5800, second data source: 2000) groups by using an auxiliary expertise classifier 2, (first data source: 5800 novice, 2200 expert; second data source: 6000 expert, 2000 novice).

100 random conversations were manually inspected and it was found that the classification was reliable (K=0.88 agreement computed between the first author and GPT-4o). Next, the intent category Creative writing and editing was considered. User groups were formed based on metadata, specifically location, partitioning users into USA (8000 conversations) and China (800 conversations). The datasets were partitioned into a 90:10 train: test split, so as to ensure no training signal leakage. Next, SAT/DSAT judgments were predicted to learn divergent preferences on the training data. GPT-4o was used to classify bot responses resulting in a subsequent user SAT, DSAT, or Neither judgment. Finetuning was performed using synthetic data constructed from the full training set.

### Models and GPA Baselines.

For rubric extraction, GPT-4o was used for tailored response generation (GPA-CT and GPA-FT), two base generative models (M) were used: gemma-2-9b-it3 and Meta-Llama-3-8B4. GPA-CT and GPA-FT were compared against several baselines: a) Zero-shot (Base) responses, b) Persona-Aware (Persona-G): which augments the input prompt with group-aware persona (G) information to mimic responses from specific user-groups through role-playing behavior, c) Persona-Criteria-Aware (Static-G): which uses M to first generate preference criteria for G and G′, and then append the generated criteria to the prompt, d) KTO (KTO-G): which fine-tunes a generative model with group-specific SAT and DSAT samples to tailor towards each group using KTO, e) KTO-Augmented (KTO-G+): which also uses KTO to finetune a generative model on the group-specific SAT and DSAT samples, but this time augmented with the contrastive pairs generated by the rubrics.

Responses were evaluated across three dimensions:

1) Customization to Group Preferences: Alignment with group-specific preferences was assessed using Win-Tie-Lose (WTR) rates computed via GPT-4o-as-a-Judge with Persona-Role Playing. WTR results for generative model judgments with confidence estimations are reported, at a confidence threshold correlated with human judgment. To mitigate positional bias, average win rates are determined by swapping response positions.

### 2) Oracle-Guided Satisfaction Estimation:

Responses that significantly deviate from DSAT-classified reference responses are identified to minimize negative follow-up feedback. This evaluation measures whether the methods generate fewer dissatisfactory signals than baselines, focusing solely on response differences without considering user personas. Success is determined by the number of times the responses outperform baselines in WTR comparisons.

### 3) Quality Evaluation on Standard Benchmarks:

The generalization of GPA-CT and GPA-FT using two open-ended instruction-following benchmarks was evaluated: MT-Bench and Arena-Hard. This ensures that the models maintain strong performance in general instruction-following tasks despite group-aware alignment. Each benchmark's evaluation protocol is followed, reporting Win Rate (WR) for Arena-Hard (with GPT-4o as the judge) and the average MT-Bench score using default inference strategies.

### Results and Findings

GPA-FT excels when ample finetuning data is available, while GPA-CT remains robust in lower-data settings. Table 1 reports the evaluation of GPA-CT and GPA-FT on a second data source Creative Writing examples across countries and first data source Programming examples across experts/novices for Llama base model.

TABLE 1
WR Evaluation of GPA-CT and GPA-FT on Creative
Writing examples across countries, and Programming
examples across experts/novices.

| | LLM Pref | LLM | LLM Pref | LLM |
|---|---|---|---|---|
| Model | (W/L/T) | conf ≥75 | (W/L/T) | conf ≥75 |
| | Intent = Programming, | | Intent = Programming, | |
| | Group = Novice | | Group = Expert | |
| GPA-CT v | 65.82/25.00/ | 67.53/32.47 | 57.10/42.04/ | 57.46/42.54 |
| Base | 9.18 | | 0.86 | |
| GPA-CT v | 60.44/31.96/ | 73.97/26.03 | 61.10/38.30/ | 61.91/38.09 |
| Persona | 7.60 | | 0.6 | |
| GPA-CT v | 56.43/37.43/ | 80.00/20.00 | 57.38/41.47/ | 59.05/40.95 |
| Static | 6.14 | | 1.6 | |
| GPA-FT v | 71.29/25.87/ | 68.05/31.95 | 53.17/40.62/ | 56.15/43.84 |
| Base | 2.84 | | 5.56 | |
| GPA-FT v | 70.98/27.76/ | 68.84/31.16 | 58.80/40.62/ | 59.62/40.37 |
| Persona | 1.26 | | 5.0 | |
| GPA-FT v | 66.88/32.18/ | 60.64/39.36 | 59.65/39.77/ | 57.72/42.27 |
| Static | 0.95 | | 0.56 | |
| GPA-FT v | 63.09/36.59/ | 57.59/42.41 | 53.12/38.35/ | 58.99/41.00 |
| GPA-CT | 0.32 | | 0.28 | |
| | Intent = Writing, | | Intent = Writing, | |
| | Group = USA | | Group = China | |
| GPA-CT v | 45.5/53.5/ | 54.1/45.9 | 58.5/23.9/ | 88.57/11.42 |
| Base | 1.0 | | 17.6 | |
| GPA-CT v | 55.5/42.5/ | 59.5/40.5 | 53.6/28.73/ | 60.0/40.00 |
| Persona | 2.0 | | 17.60 | |
| GPA-CT v | 67.02/31.00/ | 67.10/32.90 | 52.11/32.3/ | 68.57/31.43 |
| Static | 1.98 | | 15.59 | |
| GPA-FT v | 55/26.5/ | 62.2/37.8 | 55.22/20.84/ | 60.95/39.04 |
| Base | 18.5 | | 23.94 | |
| GPA-FT v | 77/21.5/1.5 | 82.4/17.5 | 35.21/40.84/ | 32.38/67.62 |
| Persona | | | 23.95 | |
| GPA-FT v | 85/14.5/0.5 | 88.5/11.5 | 28.16/54.92/ | 47.61/52.39 |
| Static | | | 16.92 | |
| GPA-FT v | 85.5/14/0.5 | 71.4/28.6 | 39.43/40.84/ | 40.95/59.05 |
| GPA-CT | | | 19.73 | |

W/L/T = win/lose/tie rates and LLM confidence.

GPA-CT improves overall satisfaction compared to baselines. Results in Table 2 (computed on the DSAT Signals in the first data source Programming) using a common LLM.

TABLE 2
WTR against the baselines (Win determines the number of times
GPA-CT is chosen over others) on first data source Programming
when compared against reference DSAT Evaluation using Llama.

| Setup | Win(%) | Lose(%) | Tie(%) |
|---|---|---|---|
| GPA-CT vs Base | 69.61% | 29.41% | 0.98% |
| GPA-CT vs Persona | 65.69% | 33.33% | 0.98% |
| GPA-CT vs Static | 76.70% | 21.36% | 1.94% |

This suggests that GPA-CT generates responses that better align with user expectations and reduces dissatisfaction signals when compared with other baselines.

GPA-FT does not compromise model performance on other benchmarks. GPA-FT models on MT-Bench and Arena-Hard were evaluated to assess if their instruction-following performance degrades on standard benchmarks. Table 3 confirms that GPA-FT does not compromise performance on the instruction-following benchmarks.

TABLE 3
Comparison against a common LLM Base on
Arena-Hard Benchmark (Win/Lose/Tie, and Win-Lose Δ)
and evaluation on MT-Bench (MT-B).

| Model | WR | LR | TR | Δ(%) | MT-B |
|---|---|---|---|---|---|
| Base | | | | | 8.32 |
| Novice GPA-FT | 49.11 | 39.1 | 8.62 | +10.01 | 8.33 |
| Expert GPA-FT | 47.89 | 42.88 | 6.41 | +5.01 | 8.21 |
| US GPA-FT | 47.56 | 43.8 | 8.64 | +3.76 | 8.26 |
| China GPA-FT | 48.49 | 38.34 | 9.02 | +10.15 | 8.3 |

The MT-Bench scores for GPA-FT models remain close to the Base model (8.320), with Novice GPA-FT (8.334) even slightly outperforming it. Similarly, Arena-Hard results show a positive win-loss delta (Δ) across all groups, with China GPA-FT (+10.15%) and Novice GPA-FT (+10.01%) achieving the highest gains.

Even in Expert (+5.01%) and US (+3.76%) categories, GPA-FT maintains competitive performance. Overall these findings reinforce the fact that group preference alignment via fine-tuning does not lead to overfitting or loss of generalization.

### Further Analysis

User preferences vary across cultures and domains. Table 4 lists extracted rubrics for Creative Writing and Editing across countries and tasks.

TABLE 4
Rubric Items Differentiating the Preferences Across User Groups (Separated
by Country/Cultural Context) in the domain of Creative Writing and Editing.

| User | | | |
|---|---|---|---|
| Groups | Intent | Rubric Item | Description |
| US vs. | Writing | Personal | Western users seek vivid, personal |
| China | Assistance | Connection and | engagement, while Eastern users prefer |
| | | Passion | clear and concise communication, |
| | | | emphasizing empathy and understanding. |
| | | Historical and | Western users favor detailed historical |
| | | Anecdotal | accounts with personal anecdotes, |
| | | Content | while Eastern users prefer |
| | | | straightforward summaries with clear |
| | | | information. |
| | | Perspective and | Western users prefer second-person |
| | | Tone | perspective, addressing the audience |
| | | | directly, while Eastern users expect the |
| | | | bot to acknowledge and appreciate their |
| | | | contributions. |
| | | Refinement in | Western users prefer advanced |
| | | Narrative Style | vocabulary and polished narrative |
| | | | styles, while Eastern users value |
| | | | clarity, conciseness, and brevity. |
| US vs. | Creative | Story | US users prefer detailed and structured |
| China | Content | Continuation | script outlines, while Eastern users |
| | Creation | | expect more imaginative and action- |
| | | | packed continuations. |
| | | Role-Playing | US users may expect the assistant to |
| | | Engagement | ask for specifications, while Eastern |
| | | | users expect immediate role-play |
| | | | engagement. |
| | | Humor and | Both groups enjoy humorous and |
| | | Creative Titles | creative titles, but Eastern users |
| | | | emphasize playful and whimsical text |
| | | | more. |
| | | Cultural | Both groups value cultural resonance, |
| | | Resonance and | but Eastern users place more emphasis |
| | | Poetic Elements | on poetic elements. |
| US vs. | Writing | Acknowledgment | Indian users expect explicit |
| India | Assistance | and Appreciation | appreciation and acknowledgment of |
| | | | their contributions, while US users do |
| | | | not emphasize this as much. |
| | | Personal | US users prefer vivid engagement with |
| | | Connection and | emotions and enthusiasm, while Indian |
| | | Passion | users prioritize shared goals and |
| | | | inclusive language. |
| | | Engaging and | US users prefer engaging and |
| | | Descriptive Style | descriptive styles with coherence, while |
| | | | Indian users focus on vivid and friendly |
| | | | tones. |
| US vs. | Creative | Story | US users prefer structured and detailed |
| India | Content | Continuation | script outlines, while Indian users |
| | Creation | | expect more imaginative and action- |
| | | | packed stories. |
| | | Bedtime Story | US users expect generic stories, while |
| | | Personalization | Indian users prefer more personalized |
| | | | and interactive bedtime storytelling. |

Table 4 illustrates how cultural background significantly shapes user preferences, even for the same intent. US users prefer personal engagement and detailed narratives, while Chinese users favor clarity and structured summaries in writing and creative content. Similarly, when expertise remains constant but the domain shifts from Education to Programming, experts prioritize different aspects—educators value comprehensiveness and critical analysis, whereas programmers focus on specificity, error handling, and debugging.

Intent-Specific Rubrics are important for better group-preference alignment compared to generic ones. To investigate the impact of intents in preference learning, rubrics were extracted from the first data source expertise groups in two ways: without considering intent and with intent-awareness. These rubrics were then used for context-tuning on a held-out test set, followed by WTR evaluation using Persona-based evaluation.

FIG. 13 illustrates, by way of example, a bar graph of a WTR evaluation using the Gemma model. The results in FIG. 13 show a notable drop in WR when intent was not used, demonstrating that intent-aware rubric extraction leads to more personalized, contextually aligned responses.

Preference rubrics degrade significantly when expertise labels are randomly flipped, indicating robustness. Robustness of the extracted rubrics was tested by randomly flipping expertise labels and extracting out the preference rubrics using GPA.

FIG. 14 illustrates, by way of example, line graphs of a number of valid rubrics versus type of minibatching for a variety of intents. The graphs of FIG. 14 highlights the impact of random shuffling of expertise labels on rubric generation across various intents, where the validity of generated rubrics is determined by a self-correcting evaluation prompt from GPA. The results demonstrate that valid rubric generation is most successful under an original generation strategy (Gen) with correctly aligned expertise labels. However, as expertise labels are randomly shuffled (R1, R2, R3), the number of valid rubrics decreases significantly, often to zero, which confirm the robustness of the extracted rubrics.

Embodiment provide group-aware personalization of generative models using a Group Preference Alignment (GPA) framework. The GPA framework identifies and incorporates diverse conversational preferences of distinct user groups via a two-step process of Group-Aware Preference Extraction and Tailored Response Generation. Experiments demonstrate that GPA significantly enhances the alignment of generative model outputs with group-specific preferences. GPA out-performs baseline methods with respect to preferences while maintaining robust performance on the standard information-following benchmarks.

Example 1 includes a method for aligning generative model responses with group-specific user preferences, comprising prompting a first generative model to extract and associate implicit judgments from user responses in real-world conversation logs, the implicit judgments indicating preferred or dis-preferred with a conversation associated with a respective conversation log of the conversation logs, prompting the first or a second generative model to summarize the implicit judgements from the first generative model into generalized preference aspects resulting in group-specific rubrics, the group-specific rubrics indicate significant differences in the generalized preference aspects between groups, and based on the group-specific rubrics from the generative model, (i) augmenting a prompt to a third generative model resulting in an augmented prompt and providing the augmented prompt to the third generative model or (ii) fine-tuning the third generative model, resulting in a group-aligned generative model that provides responses in alignment with a group-specific rubric of the group-specific rubrics.

In Example 2, Example 1 further includes receiving a partial conversation log of a conversation between a user and the third generative model, and determining, by prompting the first generative model and based on the partial conversation log, a group to which the user belongs, the group associated with an expertise in a subject matter, a geographical region, or a combination thereof.

In Example 3, Example 2 further includes, wherein augmenting includes altering the prompt to the third generative model to include a group-specific rubric of the group-specific rubrics associated with the group of the user.

In Example 4, Example 3 further includes, wherein the group-specific rubric summarizes intent-specific guidance for generative model responses for the group.

In Example 5, at least one of Examples 2-4 further includes, wherein fine-tuning includes altering the third generative model by finetuning the generative model.

In Example 6, Example 5 further includes, wherein finetuning the third generative model includes training the third generative model based on pairs of contrastive augmented conversation examples, the pairs of contrastive augmented conversation examples including conversation examples associated with an implicit judgement of preferred and conversation examples associated with an implicit judgement of dis-preferred.

In Example 7, Example 6 further includes, wherein a first contrastive augmented conversation example of a pair of the contrastive augmented conversation examples is synthetically generated and a second contrastive augmented conversation example of the pair is from real-world conversation logs.

In Example 8, Example 7 further includes, wherein finetuning includes using a direct preference optimization function that trains the third generative model to provide responses aligned with the rubric and to not provide responses reflecting the conversation examples that are dis-preferred.

In Example 9, at least one of Examples 1-8 further includes, wherein summarizing the implicit judgments into generalized preference aspects to create group-specific rubrics includes prompting the first generative model to, based on conversations between the third generative model and corresponding users of groups of users, provide an indication of whether the user was satisfied or dissatisfied with the conversation and an explanation of why the user was satisfied or dissatisfied, identifying divergent preferences between groups of users based on whether the user was satisfied or dissatisfied and the explanations, and scoring the divergent preferences.

In Example 10, Example 9 further includes, wherein summarizing the inferred expectations into generalized preference aspects to create group-specific rubrics further includes adding a divergent preference of the divergent preferences to a corresponding group-specific rubric of the group-specific rubrics.

Example 11 includes a non-transitory machine-readable medium including instructions that, when executed by a machine, cause the machine to perform operations comprising obtaining (i) a user query to a first generative model by a user and (ii) a partial conversation associated with the user query, retrieving, based on a group of groups to which the user belongs and from a rubric database, a group-specific rubric of previously stored group-specific rubrics, dynamically adjusting the user query during inference by incorporating the group-specific rubric into a prompt, resulting in an augmented prompt, providing the augmented prompt to the first generative model, and providing a response to the augmented prompt, and from the first generative model, to the user.

In Example 12, Example 11 further includes, wherein the group is associated with an expertise in a subject matter, a geographical region, or a combination thereof.

In Example 13, at least one of Examples 11-12 further includes, wherein the group-specific rubric summarizes intent-specific guidance for generative model responses for the group.

Example 14 includes a system comprising a memory comprising instructions, processing circuitry configured to execute the instructions, the instructions, when executed, cause the processing circuitry to perform operations comprising prompting a first generative model to extract and associate implicit judgments from user responses in real-world conversation logs, the implicit judgments indicating preferred or dis-preferred with a conversation associated with a respective conversation log of the conversation logs, prompting the first or a second generative model to summarize the implicit judgements from the first generative model into generalized preference aspects resulting in group-specific rubrics, the group-specific rubrics indicate significant differences in the generalized preference aspects between groups, and based on the group-specific rubrics from the generative model, (i) augmenting a prompt to a third generative model resulting in an augmented prompt and providing the augmented prompt to the third generative model or (ii) fine-tuning the third generative model, resulting in a group-aligned generative model that provides responses in alignment with a group-specific rubric of the group-specific rubrics.

In Example 15, Example 14 further includes, wherein the instructions further comprise receiving a partial conversation log of a conversation between a user and the third generative model, and determining, based on the partial conversation log and by prompting the first generative model, a group to which the user belongs, the group associated with an expertise in a subject matter, a geographical region, or a combination thereof.

In Example 16, Example 15 further includes, wherein the instructions further comprise routing a prompt associated with a next turn of a conversation associated with the conversation log to the group-aligned generative model.

In Example 17, at least one of Examples 15-16 further includes, wherein the group-specific rubric summarizes intent-specific guidance for generative model responses for the group.

In Example 18, at least one of Examples 15-17 further includes, wherein summarizing the implicit judgments into generalized preference aspects to create group-specific rubrics includes prompting the first generative model to, based on conversations between the third generative model and corresponding users of groups of users, provide an indication of whether the user was satisfied or dissatisfied with the conversation and an explanation of why the user was satisfied or dissatisfied, identifying divergent preferences between groups of users based on whether the user was satisfied or dissatisfied and the explanations, and scoring the divergent preferences.

In Example 19, at least one of Examples 15-18 further includes, wherein finetuning the third generative model includes training the third generative model based on pairs of contrastive augmented conversation examples and a direct reference optimization objective function, the pairs of contrastive augmented conversation examples including conversation examples associated with an implicit judgement of preferred and conversation examples associated with an implicit judgement of dis-preferred.

In Example 20, Example 19 further includes, wherein a first contrastive augmented conversation example of a pair of the contrastive augmented conversation examples is synthetically generated and a second contrastive augmented conversation example of the pair is from real-world conversation logs.

Although teachings have been described with reference to specific example teachings, it will be evident that various modifications and changes may be made to these teachings without departing from the broader spirit and scope of the teachings. Accordingly, the specification and drawings are to be regarded in an illustrative rather than a restrictive sense. The accompanying drawings that form a part hereof, show by way of illustration, and not of limitation, specific teachings in which the subject matter may be practiced. The teachings illustrated are described in sufficient detail to enable those skilled in the art to practice the teachings disclosed herein. Other teachings may be utilized and derived therefrom, such that structural and logical substitutions and changes may be made without departing from the scope of this disclosure. This Detailed Description, therefore, is not to be taken in a limiting sense, and the scope of various teachings is defined only by the appended claims, along with the full range of equivalents to which such claims are entitled.

1. A method for aligning generative model responses with group-specific user preferences, comprising:
prompting, by a processing system, a first generative model to extract and associate, based on user satisfaction signals in real-world conversation logs, implicit judgments from user responses in the real-world conversation logs with the real-world conversation logs, the implicit judgments indicating preferred or dis-preferred with a conversation associated with a respective conversation log of the real-world conversation logs;
prompting, by the processing system, the first or a second generative model to summarize the implicit judgments from the first generative model into generalized preference aspects resulting in group-specific rubrics by iteratively processing, across multiple user groups, batches of the implicit judgments and identifying divergent preference aspects between the multiple user groups, the group-specific rubrics indicate significant differences in the generalized preference aspects between groups; and
based on the group-specific rubrics from the generative model, automatically augmenting, during inference, a prompt to a third generative model by incorporating a group-specific rubric selected based on an identified group membership of a user resulting in an augmented prompt and providing the augmented prompt to the third generative model.

2. The method of claim 1, further comprising:
receiving a partial conversation log of a conversation between a user and the third generative model; and
determining, by prompting the first generative model and based on the partial conversation log, a group to which the user belongs, the group associated with an expertise in a subject matter, a geographical region, or a combination thereof.

3. The method of claim 2, wherein augmenting includes altering the prompt to the third generative model to include a group-specific rubric of the group-specific rubrics associated with the group of the user.

4. The method of claim 3, wherein the group-specific rubric summarizes intent-specific guidance for generative model responses for the group.

5. The method of claim 2, wherein fine-tuning includes altering the third generative model by finetuning the generative model.

6. The method of claim 5, wherein finetuning the third generative model includes training the third generative model based on pairs of contrastive augmented conversation examples, the pairs of contrastive augmented conversation examples including conversation examples associated with an implicit judgment of preferred and conversation examples associated with an implicit judgment of dis-preferred.

7. The method of claim 6, wherein a first contrastive augmented conversation example of a pair of the contrastive augmented conversation examples is synthetically generated and a second contrastive augmented conversation example of the pair is from real-world conversation logs.

8. The method of claim 7, wherein finetuning includes using a direct preference optimization function that trains the third generative model to provide responses aligned with the rubric and to not provide responses reflecting the conversation examples that are dis-preferred.

9. The method of claim 1, wherein summarizing the implicit judgments into generalized preference aspects to create group-specific rubrics includes:
prompting the first generative model to, based on conversations between the third generative model and corresponding users of groups of users, provide an indication of whether the user was satisfied or dissatisfied with the conversation and an explanation of why the user was satisfied or dissatisfied;
identifying divergent preferences between groups of users based on whether the user was satisfied or dissatisfied and the explanations; and
scoring the divergent preferences.

10. The method of claim 9, wherein summarizing the implicit judgments into generalized preference aspects to create group-specific rubrics further includes adding a divergent preference of the divergent preferences to a corresponding group-specific rubric of the group-specific rubrics.

11. A non-transitory machine-readable medium including instructions that, when executed by a machine, cause the machine to perform operations comprising:
prompting a first generative model to extract and associate, based on user satisfaction signals in real-world conversation logs, implicit judgments from user responses in the real-world conversation logs with the real-world conversation logs, the implicit judgments indicating preferred or dis-preferred with a conversation associated with a respective conversation log of the real-world conversation logs;
prompting the first or a second generative model to summarize the implicit judgments from the first generative model into generalized preference aspects resulting in group-specific rubrics by iteratively processing, across multiple user groups, batches of the implicit judgments and identifying divergent preference aspects between the multiple user groups, the group-specific rubrics indicating significant differences in the generalized preference aspects between groups;
obtaining (i) a user query to a first generative model by a user and (ii) a partial conversation associated with the user query;
retrieving, based on a group of groups to which the user belongs and from a rubric database, a group-specific rubric of previously stored group-specific rubrics;
automatically augmenting, during inference, the user query by incorporating the group-specific rubric into a prompt, resulting in an augmented prompt;
providing the augmented prompt to a third generative model; and
providing a response to the augmented prompt, and from the third generative model, to the user.

12. The non-transitory machine-readable medium of claim 11, wherein the group is associated with an expertise in a subject matter, a geographical region, or a combination thereof.

13. The non-transitory machine-readable medium of claim 11, wherein the group-specific rubric summarizes intent-specific guidance for generative model responses for the group.

14. A system comprising:
a memory comprising instructions;
processing circuitry configured to execute the instructions, the instructions, when executed, cause the processing circuitry to perform operations comprising:
prompting a first generative model to extract and associate, based on user satisfaction signals in real-world conversation logs, implicit judgments from user responses in the real-world conversation logs with the real-world conversation logs, the implicit judgments indicating preferred or dis-preferred with a conversation associated with a respective conversation log of the real-world conversation logs;
prompting the first or a second generative model to summarize the implicit judgments from the first generative model into generalized preference aspects resulting in group-specific rubrics by iteratively processing, across multiple user groups, batches of the implicit judgments and identifying divergent preference aspects between the multiple user groups, the group-specific rubrics indicate significant differences in the generalized preference aspects between groups; and
based on the group-specific rubrics from the generative model, automatically augmenting, during inference, a prompt to a third generative model by incorporating a group-specific rubric selected based on an identified group membership of a user resulting in an augmented prompt and providing the augmented prompt to the third generative model.

15. The system of claim 14, wherein the instructions further comprise:
receiving a partial conversation log of a conversation between a user and the third generative model; and
determining, based on the partial conversation log and by prompting the first generative model, a group to which the user belongs, the group associated with an expertise in a subject matter, a geographical region, or a combination thereof.

16. The system of claim 15, wherein the instructions further comprise routing a prompt associated with a next turn of a conversation associated with the conversation log to the third generative model.

17. The system of claim 15, wherein the group-specific rubric summarizes intent-specific guidance for generative model responses for the group.

18. The system of claim 15, wherein summarizing the implicit judgments into generalized preference aspects to create group-specific rubrics includes:
prompting the first generative model to, based on conversations between the third generative model and corresponding users of groups of users, provide an indication of whether the user was satisfied or dissatisfied with the conversation and an explanation of why the user was satisfied or dissatisfied;
identifying divergent preferences between groups of users based on whether the user was satisfied or dissatisfied and the explanations; and
scoring the divergent preferences.

19. The system of claim 15, wherein finetuning the third generative model includes training the third generative model based on pairs of contrastive augmented conversation examples and a direct reference optimization objective function, the pairs of contrastive augmented conversation examples including conversation examples associated with an implicit judgment of preferred and conversation examples associated with an implicit judgment of dis-preferred.

20. The system of claim 19, wherein a first contrastive augmented conversation example of a pair of the contrastive augmented conversation examples is synthetically generated and a second contrastive augmented conversation example of the pair is from real-world conversation logs.
